(19) United States
(12) Patent Application Publication
(10) Pub. No.: US 2009/0311420 A1
(43) Pub. Date: Dec. 17, 2009

(54) Method for making parallel passage contactors

(76) Inventors: Mark Drlik, Surrey (CA); Andrew Koutsandreas, Vancouver (CA); Brian G. Sellars, Coquitlam (CA)

Correspondence Address: KLARQUIST SPARKMAN, LLP, 121 SW SALMON STREET, SUITE 1600, PORTLAND, OR, 97204, US

(21) Appl. No.: 11/794,646

(22) PCT Filed: Jan. 3, 2006
(86) PCT No.: PCT/CA2006/000001

§ 371 Date: Apr. 24, 2008

Related U.S. Application Data
(60) Provisional application No. 60/641,304, filed on Jan. 3, 2005.

(51) Int. Cl. B05D 3/12; B05D 5/00

(52) U.S. Cl. 427/179; 427/288

(57) ABSTRACT

An inventive method for making a parallel passage contactor structure comprising multiple sheet material layers is provided. A substantially continuous printing device, such as a rotary screen printer, or optionally alternative suitable substantially continuous printing means including for example repeated non-rotary screen or stencil printing, may be used to affix printed spacers comprising a printed spacer ink onto a substantially continuous web of a chosen sheet material, which may subsequently be spirally wound about a mandrel to form a spiral parallel passage contactor structure with multiple sheet material layers spaced apart from each other by the affixed printed spacer means to form fluid flow channels.

### FIELD

The present disclosure relates to parallel passage contactors and particularly to a method for making parallel passage contactors having improved spacing means to control the dimensions of flow channels between adjacent sheet structures comprising the contactor structure.

### BACKGROUND

Parallel passage contactor structures are known in the art for contacting fluid or gas streams with solid surfaces, such as for adsorptive separation of gas streams. In particular, parallel passage contactor structures for use as adsorbent structures are known for application to cyclical adsorption processes such as pressure and/or temperature swing adsorption and particularly rapid-cycle and/or rotary pressure swing adsorption as disclosed in the Applicant's U.S. Pat. Nos. 6,051,050, 6,451,095, and 6,406,523, the contents of which are hereby incorporated by reference. Some methods for making parallel passage contactors for use as adsorbent structures comprising multiple adsorbent sheet layers spaced apart to define fluid (particularly gas) flow channels are disclosed in the Applicant's co-pending U.S. patent application Ser. No. 10/041,536, the contents of which are herein incorporated by reference. In particular certain methods of producing adsorbent sheets such as for use in a parallel passage adsorbent structures are disclosed. Additionally, certain methods of assembling multiple adsorbent sheets in combination with printed spacer means for use as parallel passage adsorbent structures are disclosed.

### SUMMARY OF THE INVENTION

According to a first embodiment of the present invention, a method for making a parallel passage contactor structure comprising multiple sheet material layers is provided wherein a continuous printing means, such as a rotary screen printer, or optionally alternative suitable substantially continuous printing means including for example repeated non-rotary screen or stencil printing, may be used to affix a printed spacer means comprising a printed spacer ink onto a desirably substantially continuous web of a chosen sheet material, following which a spiral winding means may be used to spirally wind the sheet material and affixed printed spacer means around itself to form a spiral parallel passage contactor structure with multiple sheet material layers spaced apart from each other by the affixed printed spacer means to form fluid flow channels. In an exemplary such an embodiment, the printed spacer ink may comprise microspheres or similar alternatively shaped small particles of defined dimension in order to control the height of the printed spacer means when pressed between two adjacent layers of sheet material in the parallel passage contactor structure. Such an embodiment of the present invention providing for the printing of spacer means onto a substantially continuous web of sheet material and desirably including microspheres or similar particles for controlling the spacing between adjacent sheets in a parallel passage contactor structure offers advantages in both efficiency and scalability of production of the resulting parallel passage contactor structure. In an embodiment of the present inventive method, the printed spacer ink may additionally comprise an adhesive material such that following winding of the sheet material around itself to form a multilayered parallel passage contactor structure, the adjacent layers of sheet material may be bonded to each other by such adhesive material comprised in the printed spacer means pressed between the layers of sheet material. The substantially continuous printing means and winding means may be arranged sequentially such that the web of sheet material may pass through the continuous printing means and thereafter the winding means in a substantially continuous manner. Therefore, in an exemplary embodiment, a printed spacer ink comprising an adhesive material may be affixed to the sheet material in a plastic uncured state, and the sheet material may be wound around itself while the adhesive material remains in a substantially plastic and uncured state and subsequently cures to a non-plastic bonded cured state after winding, bonding the adjacent layers of the sheet material together as a bonded parallel passage contactor structure. Such an embodiment of the present invention combining printing of the printed spacer means and bonding of the layers of the structure into substantially a single continuous process offers further advantages in efficiency and scalability of production of a spirally wound parallel passage contactor structure comprising printed spacer means relative to the methods according to the prior art.

As is known in the art, parallel passage contactor structures may be utilized in many applications requiring relatively high surface areas of a solid material for contact with a fluid, particularly for structures which desirably provide for low fluid pressure drop through the contactor structure. Spiral wound parallel passage contactor structures made according to embodiments of the above described inventive method may comprise any suitable sheet material desired for use in contact with a fluid such as a gas or liquid to be passed through the contactor structure. For example, in the case of a catalyst contactor structure, a ceramic or zeolite based sheet material coated or impregnated with a catalyst material may be used as the sheet material in order to form a catalytic contactor structure with high surface area and low pressure drop. In such a case, the printed spacer ink material may be selected to be suitable for use at the particular physical conditions of temperature, pressure, etc. required during operation of the desired catalytic contactor structure. In another exemplary application of the parallel passage contactor structures made according to the above inventive method, sheet material comprising NOX absorbent material may be used in order to form a desirably high surface area and low pressure drop NOX absorber parallel passage contactor structure. Similarly, a printed spacer ink material may be selected that is suitable for use at the physical conditions present during operation of such a NOX absorber structure. In general, the materials and compositions selected for the sheet material, printed spacer ink and any spacing and/or adhesive material means may be chosen from those suitable for use at the physical conditions present during operation of the process for which the parallel passage contactor structure is desired.

In a second embodiment of the present invention particularly adapted for making parallel passage contactor structures for use as adsorbent structures in rapid-cycle adsorptive gas separation processes, a method for making a parallel passage adsorbent structure comprising multiple layers of adsorbent sheet material is provided wherein a substantially continuous printing means, such as a rotary screen printer for example, may be used to affix a printed spacer means comprising a printed spacer ink onto the adsorbent sheet material, following which a spiral winding means may be used to spirally wind the adsorbent sheet material and affixed printed spacer means around itself to form a spiral parallel passage adsorbent structure with multiple layers of adsorbent sheet material spaced apart from each other by the affixed printed spacer means to form gas flow channels. As in the method of the first embodiment disclosed above, the printed spacer ink may comprise microspheres or similar solid particles of defined dimension in order to control the height of the printed spacer means when pressed between two adjacent layers of adsorbent sheet material in the parallel passage adsorbent structure. The printed spacer ink may also comprise an adhesive material such that following winding of the adsorbent sheet material around itself to form a multilayered parallel passage adsorbent structure, the adjacent layers of adsorbent sheet material may be bonded to each other by the printed spacer means pressed between the layers of adsorbent sheet material. The printing ink may also optionally comprise an adsorbent material, such that the printed spacer means may contribute to the adsorptive function of the parallel passage contactor structure. Also similar to the first embodiment above, the continuous printing means and winding means may preferably be arranged sequentially such that the adsorbent sheet material may pass through the substantially continuous printing means and thereafter the winding means in a substantially continuous manner such that an exemplary printed spacer ink comprising an adhesive material may be affixed to the adsorbent sheet material in a plastic uncured state, and the adsorbent sheet material may be wound around itself while the adhesive material remains in a substantially plastic uncured state and subsequently cures to a bonded cured state after winding, bonding the adjacent layers of the adsorbent sheet material together as a bonded parallel passage adsorbent structure.

Any suitable adsorbent sheet material comprising an adsorbent material useful for adsorptive separation of a desired feed gas stream may be used in the present second embodiment of the inventive method, such as adsorbent sheet materials comprising coated adsorbent sheets, adsorbent cloth or fabrics, self-supported adsorbent sheets, or combinations thereof. In particular, adsorbent sheets formed by coating any desired adsorbent material on a support material (such support material may comprise adsorptive material such as activated carbon fibers, cloth or fabric, or non-adsorptive material such as fibreglass scrim or metallic mesh) such as are disclosed in the Applicant's copending U.S. patent application Ser. No. 10/041,536 may be used in the second embodiment of the inventive method to make a multilayer parallel passage adsorbent structure suitable for rapid-cycle adsorptive separation processes. Feed gas streams to be separated by such rapid-cycle adsorptive separation processes may be passed through the spiral parallel passage adsorbent structure resulting from the present method, and separated into gas streams comprising adsorbed and non-adsorbed components of the feed gas stream by suitable rapid cycle adsorptive separation processes such as rapid cycle pressure swing, temperature swing or displacement purge processes, or combinations thereof, such as are known in the art, examples of which are disclosed in the Applicant's copending U.S. patent applications and granted patents mentioned above, and additionally including U.S. patent application Ser. Nos. 10/039,491 and 10/389,539 the contents of which are herein incorporated by reference.

### BRIEF DESCRIPTION OF THE DRAWINGS

FIG. 1 depicts a perspective view of a rotary screen printing apparatus such as may be suitable to implement an embodiment of the present inventive method incorporating continuously printed spacing means.

FIG. 2 depicts a cross sectional view of a sheet material incorporating printed spacing means wound around a central mandrel such as may be suitable to implement an embodiment of the present inventive method for assembling a parallel passage contactor structure.

FIG. 3 depicts a cross sectional view of two sheets of material spaced apart by a printed spacing means comprising at least one micro-sphere such as may be suitably implemented according to an embodiment of the present inventive method for assembling a parallel passage contactor structure.

FIG. 4 depicts a cross sectional view of an alternative embodiment of the inventive method utilizing a rotary screen printer to print spacing means onto a transfer web, said spacing means which are then transferred onto a desired sheet material prior to winding of the sheet material to form a parallel passage contactor structure.

### DETAILED DESCRIPTION OF SEVERAL EMBODIMENTS

In a first disclosed embodiment of the inventive method for making a multi-layer parallel passage adsorbent contactor structure such as for use in a rapid-cycle adsorption system, a rotary screen printer may be used as a substantially continuous printing means to print a series of printed spacers comprising a printing ink onto at least one layer of adsorbent sheet material, which may preferably pass through the printing means as a substantially continuous web of sheet material. Following printing of printed spacers, the web of adsorbent sheet material may be wound around a mandrel in a preferably substantially continuous manner following the rotary screen printing process, to form a spirally wound multi-layer parallel passage contactor structure. The printing ink may optionally comprise an adhesive material to bond adjacent sheets of adsorbent material to each other to form a bonded adsorbent contactor structure following the winding process. The printing ink may optionally also comprise microspheres or similar particles of defined dimension to allow precise control of the height of the printed spacers upon winding or otherwise pressing adjacent layers of adsorbent sheet material together. In such a manner, the microspheres may be chosen according to the desired height of the fluid flow channel for a given desired contactor structure, as the fluid flow channel is formed by the height of the printed spacers between adjacent adsorbent sheet material layers. Alternatively, in some exemplary embodiments, printed spacer ink comprising an adhesive material may be used which may be partially cured following printing of the printed spacer means, such that the height of the printed spacers may be substantially fixed, but such that bonding of the adjacent layers of sheet material may still occur following spiral winding of the parallel passage structure. Such partial curing and final bonding behaviour may be achieved using printed spacer ink materials which utilize heat/UV or chemical bonding processes, which may be applied following printing of the spacers to partially cure and fix the height of the spacer, and following winding to complete the bonding of the adjacent layers of the structure. In such an alternative exemplary embodiment, such partial curing printed spacer ink materials may replace the need for microspheres or other similar dimensioned particles in the printed spacer ink to control the height of the printed spacers, and consequently the height of the fluid flow channels in the parallel passage structure.

In alternative embodiments, other non-rotary substantially continuous printing means may be used to attach the printed spacers comprising the printing ink onto the sheet material, such as a stencil printer, or non-rotary screen printer. Further, a printing ink dispensing means capable of substantially continuously dispensing a controlled amount of printing ink in the form of a suitable printed spacer means, such as through an orifice or other opening under pressure, may be used in place of the continuous printing means.

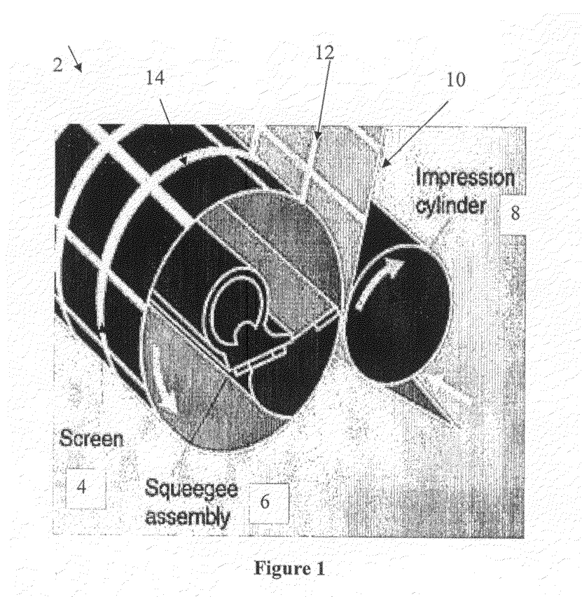

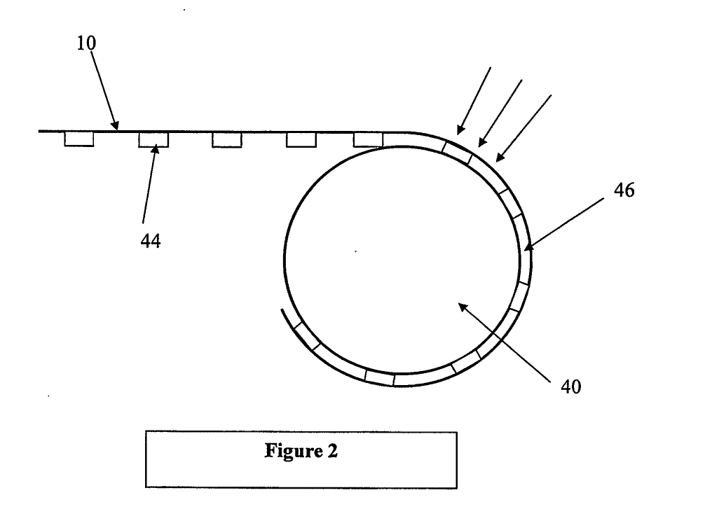

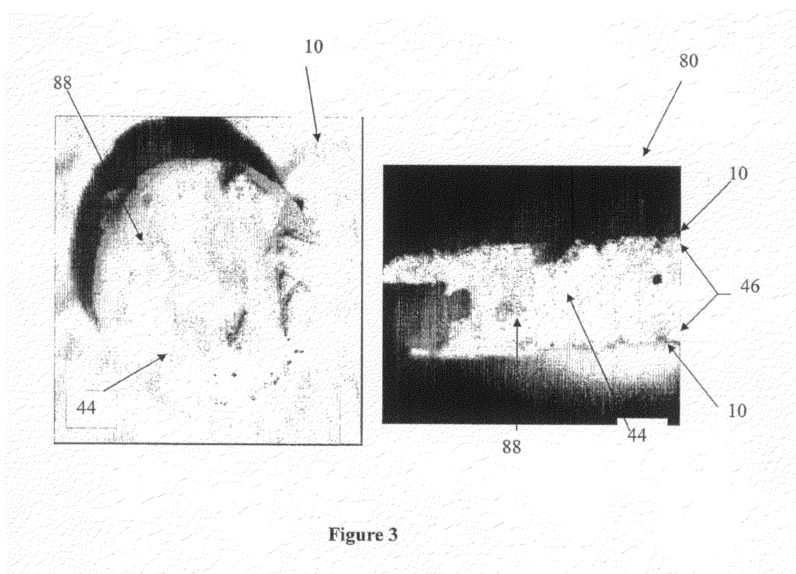

According to the first disclosed embodiment of the inventive method above, in a preferred version, the rotary screen printer may be a rotary screen textile printing system such as is available from Stork Prints BV. A simplified perspective view of an example of such rotary screen textile printing system is depicted as FIG. 1. The exemplary rotary screen textile printing system 2 may generally comprise a rotary screen 4, with internal squeegee assembly 6 adapted to force printing ink 12 through the apertures 14 in rotary screen 4 to apply the printing ink 12 onto the sheet material 10. Sheet material 10 preferably passes between rotary screen 4 and impression cylinder 8 to maintain positive contact between the rotary screen 4 and sheet material 10. The apertures 14 in rotary screen 4 may be adapted in shape and configuration (including the shape of the apertures, thickness of rotary screen, and any taper or other geometric variation of the apertures as may be desirable to tailor the form of the applied printing ink on the sheet material) to apply the printing ink 12 to the sheet material 10 in a suitable configuration to form printed spacers 44 (as shown in an exemplary cylindrical configuration in FIGS. 2 and 3) on the sheet material. Such suitable printed spacer configurations may include cylinders, prisms of various geometrical shapes (such as square or rectangular), tapered cylinders, or combinations thereof, arranged on the surface of the sheet material in a regular or irregular pattern to form suitable printed spacers to space apart adjacent layers of sheet material to form flow channels in the desired end-product parallel passage contactor structure. In a preferred embodiment, the printed spacers 44 may be cylindrical in shape and be oriented in a regular pattern of rows, such that the printed spacers applied to adjacent layers of sheet material are substantially aligned with each other in the direction perpendicular to the surface of the sheets. Alternatively, the printed spacers may be in the form of relatively continuous or discontinuous lines of printed material and may be preferably oriented generally in the direction of intended fluid flow through the parallel passage contactor structure produced by the present inventive method. In such a manner, the substantially linear printed spacers may function to at least partially direct or control the flow of fluid through the contactor structure.

Following application of printed spacers 44 by a continuous printing means such as the rotary screen printer described above, the sheet material 10 may preferably be passed around a mandrel 40 as illustrated in FIG. 2, in order to enable the spiral winding of sheet material 10 and attached printed spacers 44 in concentric layers. Such concentric spiral winding of the sheet material 10 and printed spacers 44 around a mandrel 40 may be used to produce a multilayered parallel passage contactor structure according to the inventive method, wherein the parallel passage contactor structure includes flow channels 46 between the layers of sheet material, due to the presence of the printed spacers 44. As mentioned above, in a preferred embodiment according to the invention, the printed spacers 44 may comprise a printing ink which includes an adhesive material, such that the printed spacers 44 may be continuously printed in a wet or uncured state onto sheet material 10, which may subsequently be wound around a mandrel 40 while the printing ink and incorporated adhesive remain substantially uncured. The printed spacer ink and incorporated adhesive may then be allowed to substantially cure while wound around the mandrel 40. In such a manner, a bonded parallel passage contactor structure may be made in a single substantially continuous process according to the present inventive method. Alternatively, a deformable adhesive material which does not require curing, such as a pressure-sensitive adhesive, may be used in the printing ink and deposited such as by printing onto the sheet material as described above, thereby also forming a bonded parallel passage contactor structure according to the present inventive method in a single substantially continuous process.

In an alternate embodiment, traction for winding the sheet material 10 around a mandrel 40 following spacer printing may be provided by one or more surface rollers around the outside of the spirally wound sheet material around the mandrel in a surface winding arrangement, rather than from torque from the rotation of the mandrel. Such a surface winding embodiment may be particularly useful in cases which may be prone to cinching or internal slipping of the sheet material layers upon winding of many layers of sheet material by torque from the rotation of the mandrel. In addition to the use of such surface winding arrangements, or as a further alternative to such arrangements, in slippage-prone embodiments, temporary or permanent adhesive tacking of the edges of the sheet material 10 during winding may be employed to further reduce the likelihood of slippage between layers of the sheet material wound around mandrel 40. In cases utilizing printed spacer inks comprising thermal, UV or chemical cured adhesive materials, the application of heat, UV or chemical curing means (as appropriate for the adhesive in question) to an outer edge or edges of the sheet material 10 as it is wound around mandrel 40 may be used to tack the outer edges of the sheet material 10 wound around mandrel 40 to reduce or eliminate slippage between layers while spiral winding. Following such winding process, further application of curing procedures may be used to fully cure the printed spacer adhesive to form a fully bonded spiral wound structure.

In some particular exemplary embodiments, the printing ink used to print the printed spacers 44 onto sheet material 10 may comprise microspheres or similar suitable particles of defined dimension to define the height of printed spacers 44 between adjacent sheet material layers in an assembled parallel passage contactor structure. As illustrated in the cross sectional view of parallel passage contactor structure 80 shown in FIG. 3, microspheres 88 may be incorporated into the printed spacer structure 44 by addition to the printing ink, such that the microspheres 88 allow precise control of the height of the printed spacer 44 between adjacent layers of sheet material 10. The effective height of the printed spacer 44 in an assembled parallel passage contactor structure usefully defines the height of the flow channel 46 between adjacent sheet material layers, therefore, the dimensions of microspheres 88 incorporated in the printing ink used to print the printed spacers 44 can be preferably selected to control the flow channel height of a particular parallel passage contactor structure. The desired height of flow channels in a particular parallel passage contactor structure may be chosen based on the intended use of the contactor structure. Exemplary ranges for flow channel (and therefore printed spacer) height in parallel passage adsorbent structures such as for use in rapid cycle pressure swing adsorption processes, and corresponding thicknesses of adsorbent sheet materials therefore, are disclosed in the Applicant's previously published U.S. patent application Ser. No. 10/041,536, such as from about 10 to about 1000 micrometers in height. As a rough estimate, it has been found that flow channel and therefore cured spacer heights may desirably be from about 25% to about 200% of the thickness of the adsorbent sheet material used in parallel passage contactor structures for adsorptive separation purposes.

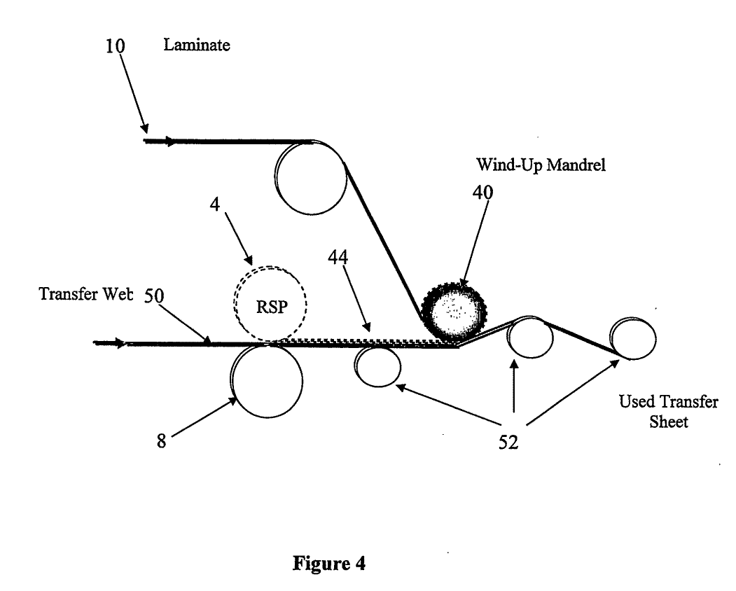

As disclosed in FIG. 4, an alternative embodiment of the inventive method is provided whereby instead of printing the printed spacers 44 comprising the printing ink 12 directly onto the desired sheet material web 10 for making a parallel passage contactor, the printed spacer means 44 may be applied to a transfer web material 50, such as by using a rotary screen printer 4 and impression roll 8, which may then subsequently be brought into contact with the desired sheet material web, such as by conveyance by means of transfer web rollers 52, to transfer the printed spacers 44 to the desired sheet material web 10. After printed spacers 44 have been transferred from the transfer web 50 to the sheet material 10, sheet material 10 may be spirally wound around a mandrel 40, or otherwise layered as described in other disclosed embodiments to form the desired parallel passage contactor structure. Also optionally, in the indirect printing embodiment incorporating a transfer web 50 disclosed above, or in the case of direct printing of the printed spacer means onto the desired sheet material web 10, the printing ink may not comprise microspheres during the printing process, but microspheres may be added to the printed spacers following printing, such as by depositing them on top of the uncured printed spacers, whereby upon subsequent spiral winding or other layering of the web material comprising the printed spacers and added microspheres, the microspheres are incorporated into the printed spacers by pressure to control the effective height of the spacers in the parallel passage contactor structure.

Suitable microspheres or other similar particles of defined dimension for use in the present inventive method may comprise a variety of materials such as glass, ceramic, polymer, metal (including thermally or electrically conductive or magnetic metals), or combinations thereof. Suitable microspheres may be substantially solid, or hollow, such as in the case of microspheres derived from fly ash. While it is preferable that the microspheres incorporated in printed spacers for use in the inventive substantially continuous print-and-wind parallel passage contactor production method be substantially spherical, such microspheres may optionally be less than ideally spherical, provided that the diameter (or external dimension in the case of semi-rectangular or other shaped particles) of such particles fall within a suitably narrow size distribution to provide the desired tolerance for flow channel height in the parallel passage contactor structure of interest. Printed spacers incorporating microspheres with particle size distributions narrower than about +/−75 microns for 90% of the sample have been found to be generally suitable for use in parallel passage adsorbent structures. It has been found that microspheres may usefully comprise between about 10% to 30% by volume of the printing ink, and in preferred embodiments, between about 15% to 25% by volume of the printing ink used in the present inventive method. It should be noted that depending on the smoothness and other potential surface characteristics of the sheet materials used in making a given parallel passage contactor structure, the viscosity or other properties of the printing ink used to form printed spacers, or the tension or confining pressure used to press adjacent sheet material layers together to form a parallel passage contactor, the average dimensions of microspheres needed to result in a desired printed spacer height and resulting flow channel height may vary, and may be best determined experimentally.

In an alternative embodiment of the present inventive method, microspheres may be incorporated in a printing ink that does not comprise adhesive material. The above disclosed method may be applied to continuously apply such a printing ink as printed spacers to a sheet material, which may be subsequently assembled such as by winding into a multilayer parallel passage contactor structure, after which the non-adhesive printing ink may be, allowed to cure. In such a manner the microspheres in the printed spacers may be used to control the height of the printed spacer and therefore the flow channels of the resulting contactor structure, but adjacent sheet layers of the structure may remain unbonded or otherwise adhered to each other. Such an un-bonded parallel passage contactor structure may be desirable in certain applications.

In a further alternative embodiment of the present inventive method, following continuous printing of printed spacers comprising adhesive printing ink containing microspheres, the sheet material with affixed printed spacers may be divided into discrete sheets while the printing ink remains in a substantially uncured state, and assembled into a parallel passage contactor structure by stacking discrete sheets on top of each other, after which the printing ink may be allowed to cure, resulting in a stacked and bonded multilayer parallel passage contactor structure. Such stacked structures may be assembled in a wide variety of shapes, such as rectangular pyramidal, tapered pyramidal, trapezoidal pyramidal, or curved variations of the aforementioned shapes, among others. Such stacked structures made according to this alternative inventive method may be desirable in certain applications requiring parallel passage contactor structures for which a wound, substantially cylindrical shape of the contactor structure may be less than optimal. Alternatively, custom shaped contactor structures may be made by cutting the desired shape from a bonded parallel passage structure made according to the above-described inventive method, including either spirally wound, or stacked structures.

In a preferred embodiment of the present invention, adapted to making parallel passage adsorbent contactor structures such as may be suitable for application to rapid-cycle adsorption processes (such as pressure swing, temperature swing, or displacement purge adsorption processes, or combinations thereof), printed spacers comprising adhesive printing ink with microspheres may be printed onto adsorbent sheet material using a rotary screen printer, after which the adsorbent sheet material may be spirally wound around a mandrel, by means of mandrel drive, or alternatively, surface winding drive to make a spirally wound, bonded multilayer parallel passage adsorbent structure with flow channel dimensions controlled by the microsphere dimensions in a substantially continuous single step process. The resulting such adsorbent structure may be advantageously incorporated as a parallel passage structured adsorbent bed in a rapid-cycle adsorption process. In such a preferred embodiment, suitable adsorbent sheet materials have been produced by means of applying a desired adsorbent material to a support material which may optionally also be adsorptively active. Suitable printing inks comprising adhesive compounds have been produced by adding glass microspheres of a desired dimension to a ceramic adhesive material such as produced by Aremco, to result in an adhesive printing ink for use in the present inventive method. Preferably, the flow channel height may be controlled by the microspheres to be in the range between about 0.002″ and 0.015″, and more particularly between about 0.003″ and 0.008″ for application of the inventive method to produce parallel passage adsorbent contactor structures for use in rapid cycle adsorption processes such as pressure swing, temperature swing, or displacement purge adsorption processes, or combinations thereof.

The present invention has been described above in reference to several exemplary embodiments. It is understood that further modifications may be made by a person skilled in the art without departing from the spirit and scope of the invention which are to be determined by the following claims.

1. A substantially continuous method for making a parallel passage contactor structure comprising sheet material separated by multiple printed spacer means to form at least one fluid flow channel between the layers of sheet material, comprising:
printing the multiple printed spacer means onto the sheet material using continuous printing means, wherein the multiple printed spacer means comprise a printing ink comprising small particles of defined dimension that control the height of the printed spacers and thereby also the height of at least one fluid flow channel in the parallel passage contactor structure; and
winding the sheet material including the multiple printed spacer means around a mandrel using spiral winding means to form the parallel passage contactor structure.

2. (canceled)

3. The method according to claim 1 further comprising:
providing an uncured composition comprising the printing ink and an adhesive material; and
allowing the composition comprising the printing ink and the adhesive material to cure and bond the multiple sheet material layers to each other to form the parallel passage contactor structure after winding about the mandrel.

4. The method according to claim 1 wherein the sheet material is an adsorbent sheet material, and the resulting parallel passage contactor structure is a parallel passage adsorbent structure.

5. The method according to claim 1 wherein the height of the at least one fluid flow channel is between about 0.002 and about 0.015 inch.

6. The method according to claim 1 wherein the sheet material is a substantially continuous web of sheet material.

7. The method according to claim 1 further comprising:
cutting the sheet material into multiple cut sheets using cutting means; and
stacking the multiple cut sheets on top of each other using stacking means to form a multiple layered parallel passage contactor structure.

8. The method according to claim 1 wherein the small particles of defined dimension are microspheres.

9. The method according to claim 1 wherein the small particles of defined dimension are cylinders, prisms or a combination thereof.

10. The method according to claim 7 wherein the cutting and stacking means is a unitary device.

11. The method according to claim 3 wherein the sheet material is an adsorbent sheet material, and the resulting parallel passage contactor structure is a parallel passage adsorbent structure.

12. A method for making a parallel passage contactor structure, comprising:
providing sheet material;
providing printing ink comprising small particles of defined dimension;
continuously printing multiple printed spacers comprising the printing ink onto the sheet material using a continuous printer; and
spirally winding the sheet material around a mandrel such that the sheets are separated from each other by multiple printed spacers to form at least one fluid flow channel between the layers of sheet material, such that the printed spacers control height of the at least one fluid flow channel in the parallel passage contactor structure.

13. The method according to claim 12 wherein the sheet material is a substantially continuous web of sheet material.

14. The method according to claim 12 further comprising:
cutting the sheet material to form multiple cut sheets; and
stacking multiple cut sheets on top of each other to form a layered parallel passage contactor structure.

15. The method according to claim 12 wherein the small particles of defined dimension are microspheres.

16. The method according to claim 12 wherein the small particles of defined dimension are cylinders, prisms, or a combination thereof.

17. The method according to claim 12 wherein the height of the at least one fluid flow channel is between about 0.002 and about 0.015 inch.

18. The method according to claim 12 wherein the sheet material is an adsorbent sheet material, and the resulting parallel passage contactor structure is a parallel passage adsorbent structure.

19. The method according to claim 14 wherein the sheet material is cut and stacked simultaneously.

20. The method according to claim 12, further comprising:
providing an uncured composition comprising the printing ink and an adhesive material; and
allowing the composition comprising the printing ink and the adhesive material to cure and bond the multiple sheet material layers to each other to form the parallel passage contactor structure, after winding about the mandrel.

21. A method for making a parallel passage contactor structure, comprising:
providing sheet material;
providing printing ink comprising small particles of defined dimension;
printing multiple printed spacers comprising the printing ink onto the sheet material;
cutting the sheet material to form multiple cut sheets; and
stacking multiple cut sheets on top of each other to form a layered parallel passage contactor structure.
